(19) United States
(12) Patent Application Publication
(10) Pub. No.: US 2022/0092605 A1
(43) Pub. Date: Mar. 24, 2022

(54) METHOD AND APPARATUS FOR INCIDENT IDENTIFICATION AND PREDICTION BASED UPON USER BEHAVIOR AND PROVIDER TOPOLOGY

(71) Applicant: SWAMPFOX TECHNOLOGIES, INC., Columbia, SC (US)

(72) Inventors: Sergey A. Razin, Columbia, SC (US); Robert S. Cooper, Irmo, SC (US)

(73) Assignee: SWAMPFOX TECHNOLOGIES, INC., Columbia, SC (US)

(21) Appl. No.: 17/479,233

(22) Filed: Sep. 20, 2021

Related U.S. Application Data
(60) Provisional application No. 63/081,086, filed on Sep. 21, 2020.

(51) Int. Cl. G06Q 30/00; G06Q 10/00; G06Q 10/06; H04M 3/51

(52) U.S. Cl. CPC G06Q 30/016; G06Q 10/20; G06Q 50/26; H04M 3/51; G06Q 10/06395

(57) ABSTRACT

Embodiments of the innovation relate to, in a contact center apparatus, a method for identifying an incident associated with a service provided by a service provider. The method comprises: receiving real-time data from a data source, the real-time data identifying a reported incident associated with a service; applying the real-time data to an incident recognition model, the incident recognition model configured to identify a state of the service provided by the service provider; in response to applying the real-time data to an incident recognition model, identifying one of an absence of a service incident and a presence of a service incident associated with the service provider; and in response to identifying the presence of the service incident, outputting an incident notification to a contact center agent device.

### RELATED APPLICATIONS

This patent application claims the benefit of U.S. Provisional Application No. 63/081,086, filed on Sep. 21, 2020, entitled, “Method and Apparatus for Incident Identification and Prediction Based Upon User Behavior and Provider Topology,” the contents and teachings of which are hereby incorporated by reference in their entirety.

### BACKGROUND

Enterprises typically utilize interactive systems to receive and distribute incoming customer omnichannel communications, such as calls, to the enterprise. For example, conventional interactive systems can provide phone-based access to an information resource associated with the enterprise, such as an email system or database. Conventional interactive systems can also route a user to a particular human resource within the enterprise, such as to a person in customer service.

Enterprises can utilize certain interactive systems, such as Interactive Voice Response (IVR) systems, to handle an enterprise's remote customer interactions with minimal, if any, human intervention. By handling some of the routine data gathering activities prior to involvement by a contact center agent, an IVR system can offload contact center agents to save on costs and can provide an efficient way for the customer to obtain routine information.

Certain service provider enterprises can utilize these interactive systems to receive requests for emergency services and to provide appropriate responses. For example, a cable service provider can receive one or more calls from its customers indicating that the cable service has been interrupted. Based upon these types of calls, the interactive system can direct a maintenance division of the cable service provider to schedule a maintenance service call or truck roll to the originating caller to address the interruption in service.

### SUMMARY

The use of conventional interactive systems by service provider enterprises can suffer from a variety of deficiencies.

For example, in the case of a cable service provider, certain components of the physical or virtual infrastructure that support the cable service provider's offering can be interrupted or fail which can create a service outage affecting a number of customers. In turn, the outage can generate a number of customer calls to the cable service provider to notify the provider of the outage and/or to request service. As a result, the agents of the cable service provider's IVR system typically address each individual service interruption call received until the cable service provider identifies the source of the interruption in service, such as due to a widespread service outage.

For example, the agents of the provider's IVR system typically schedule a service maintenance appointment and/or truck roll each one of the service interruption calls received until the cable service provider detects a widespread outage or incident. Once the cable service provider identifies the widespread outage, the provider interactive system agents can refrain from scheduling a service response or truck roll and the provider IVR can notify additional calling customers that the provider is aware of the incident and will let the customer know when the service is restored.

Accordingly, the delay between the time of occurrence of the widespread outage and the service provider's detection of the outage can be financially costly. For example, each truck roll scheduled prior to detection of the widespread outage cannot be assumed to be related to the outage. As such, each truck roll scheduled can cost the cable service provider hundreds of dollars.

By contrast to conventional use of conventional interactive systems by service provider enterprises, embodiments of the present innovation relate to a method and apparatus for incident identification and prediction based upon user behavior and provider topology. In one arrangement, a contact center system is configured to generate an incident recognition model based upon historical data related to the type of service associated with the contact center. For example, the contact center system can generate an incident recognition model that applies to any type of service that experiences a disruption, such as cable service, a gas company, or a logistic service, such as a delivery chain. The contact center system can execute the incident recognition relative to real-time user interaction data to identify and predict an incident, such as the event of a service outage, in an expedited manner in order to respond to the incident in a cost, and user-experience, efficient manner.

Embodiments of the innovation relate to, in a contact center apparatus, a method for identifying an incident associated with a service provided by a service provider. The method comprises: receiving real-time data from a data source, the real-time data identifying a reported incident associated with a service; applying the real-time data to an incident recognition model, the incident recognition model configured to identify a state of the service provided by the service provider; in response to applying the real-time data to an incident recognition model, identifying one of an absence of a service incident and a presence of a service incident associated with the service provider; and in response to identifying the presence of the service incident, outputting an incident notification to a contact center agent device.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic representation of a contact center system, according to one arrangement.

FIG. 2 illustrates a schematic representation of a feature vector, according to one arrangement.

FIG. 3 is a flowchart which illustrates a process performed by a contact center apparatus of FIG. 1 when identifying the presence of an incident associated with a service provided by a service provider.

FIG. 4 illustrates a schematic representation of a contact center system, according to one arrangement.

FIG. 5 illustrates a schematic representation of a contact center apparatus configured to check quality metrics associated with an incident recognition model, according to one arrangement.

### DETAILED DESCRIPTION

Embodiments of the present innovation relate to a method and apparatus for incident identification and prediction based upon user behavior and provider topology. In one arrangement, a contact center system is configured to generate an incident recognition model based upon historical data related to the type of service associated with the system. For example, the contact center system can generate an incident recognition model that applies to any type of service that experiences a disruption, such as cable service or a gas company, or a logistic service, such as a delivery chain. The contact center system can execute the incident recognition model relative to real-time user interaction data to identify and predict an incident, such as the event of a service outage, in an expedited manner in order to respond to the incident in a cost, and user-experience, efficient manner.

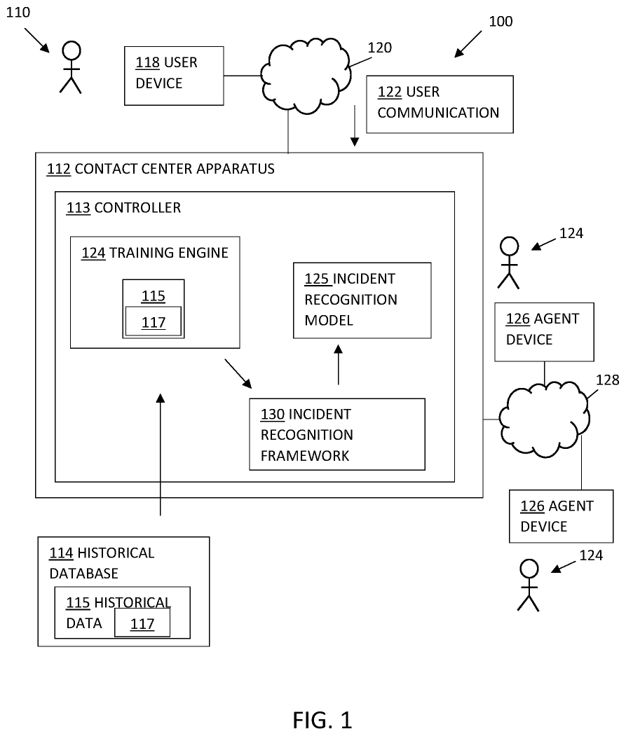

FIG. 1 illustrates a schematic representation of a contact center system 100, according to one arrangement. The contact center system 100 can include a contact center apparatus 112 disposed in electrical communication with one or more data stores or historical databases 114.

The contact center apparatus 112 can be a computerized device, such as a server device, having a controller 113, such as a processor and memory. According to one arrangement, contact center apparatus 112 is disposed in electrical communication with one or more user devices 118, such as a telephone, smartphone, or tablet device, via a network 120, such as a local area network (LAN), a wide area network (WAN), or a public switched telephone network (PSTN).

In one arrangement, the contact center system 100 can be established for a particular service provider. For example, the contact center system 100 can be established for a hospital, electric company, or internet/cable company. As such, the contact center apparatus 112 can be configured to receive real-time data 105 which pertains to the service provided by the service provider. For example, a contact center apparatus 112 associated with a hospital can be configured to receive and address user communications 122 relating to hospital services while a contact center apparatus 112 associated with an electric company can be configured to receive and address user communications 122 relating to electrical services. To identify the presence of an incident associated with the service, such as based upon received user communications 122, the controller 113 of the contact center apparatus 112 can execute an incident recognition model 125.

In one arrangement, the contact center apparatus 112 is configured to generate the incident recognition model 125 based upon the type of service associated with the contact center system 100. For example, the controller 113 can include, and be configured to execute, a training engine 124 on historical data 115 from a historical database 114 to train an incident recognition framework 130 and generate the incident recognition model 125.

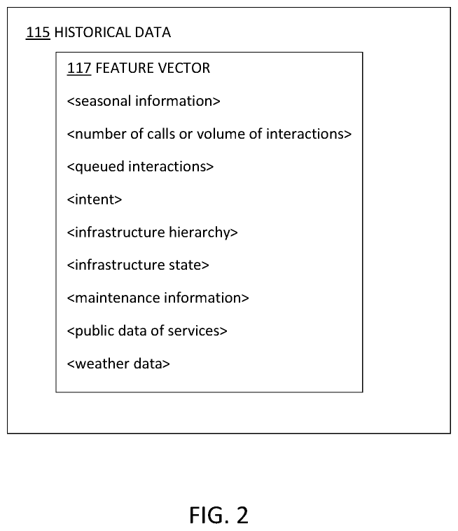

During a training operation, the training engine 124 can receive historical data 115 from the historical database 114. In one arrangement, while the historical data 115 can be configured in a variety of ways, the historical data 115 is configured as a set of feature vectors 117. While the feature vectors 117 can include a variety of elements, in one arrangement as illustrated in FIG. 2, each feature vector 117 includes data related to the following elements: <seasonal information>, <number of calls or volume of interactions>, <queued interactions>, <intent>, <infrastructure hierarchy>, <infrastructure state>, <maintenance information>, <public data of services>, and <weather data>.

Each element within the feature vector 117 is configured to provide information used by the contact center apparatus 112 to identify the state of the associated service provider's service. For example, the <seasonal information> element can identify a particular timeframe associated with a particular type of weather (e.g., summer, hurricane season, etc.). In another example, the <infrastructure hierarchy> element relates to the arrangement of the computer architecture (e.g., infrastructure nodes) of the contact center system 100. In another arrangement, the <infrastructure state> element can identify the operational state of the infrastructure associated with a given service. For example, for an electrical service, the <infrastructure state> element can indicate whether the lights for a user 110 are on or off or whether or not the infrastructure of the electrical service provider are in an emergency state. In another example, the <maintenance information> element can identify whether or not the infrastructure of the service is in a maintenance mode. In another example, the <public data of services> element can identify public information which relates to the service provided by the organization. In one arrangement, for an electrical service, the <public data of services> element can provide information identifying an infrastructure repair, such as a road repair, that necessitated turning off a service, such as an electrical service, in a given location.

The training engine 124 is configured to provide the historical data 115 to an incident recognition framework 130 to train the framework 130 and generate a resulting incident recognition model 125. While the incident recognition framework 130 can be configured in a variety of ways, in one arrangement, the incident recognition framework 130 is an algorithm, such as a gradient boosting algorithm. Boosting is an ensemble approach that that builds on weak predictors in order to generate a stronger predictor. By leveraging weak prediction models to identify relatively important data features, the gradient boosting algorithm can generate a relatively strong prediction model 125.

During the training operation, following receipt of the historical data 115, the training engine 124 can call an API to train the incident recognition framework 130 (e.g., gradient boosting algorithm) on the historical data 115. For example, the API can cause the incident recognition framework 130 to perform its operations over and over relative to the historical data 115 to find the optimal parameters which have the biggest decrease on a particular function, such as a loss function. The training engine 124 provides the optimized incident recognition framework 130 as the incident recognition model 125 for use by the contact center apparatus 112 to identify the presence of a service incident based upon incoming real-time data 150.

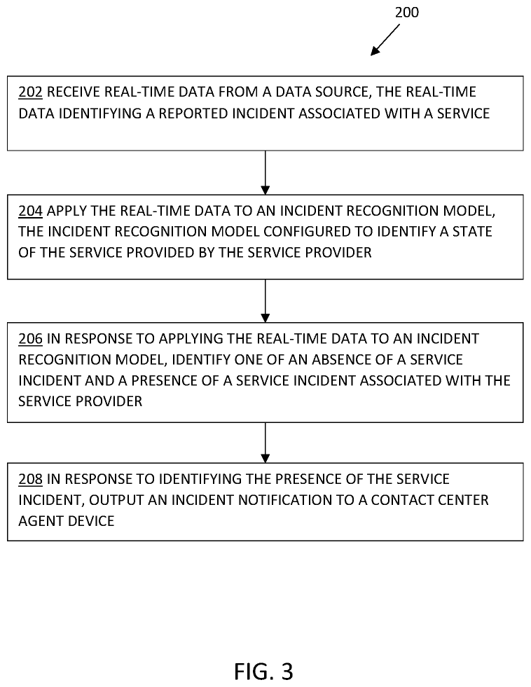

During operation, the contact center apparatus 112 is configured to apply the machine learning incident recognition model 125 to identify incidents occurring in a particular service provider's industry. FIG. 3 is a flowchart 200 which illustrates a process performed by the contact center apparatus 112 when identifying the presence of an incident associated with a service provided by a service provider.

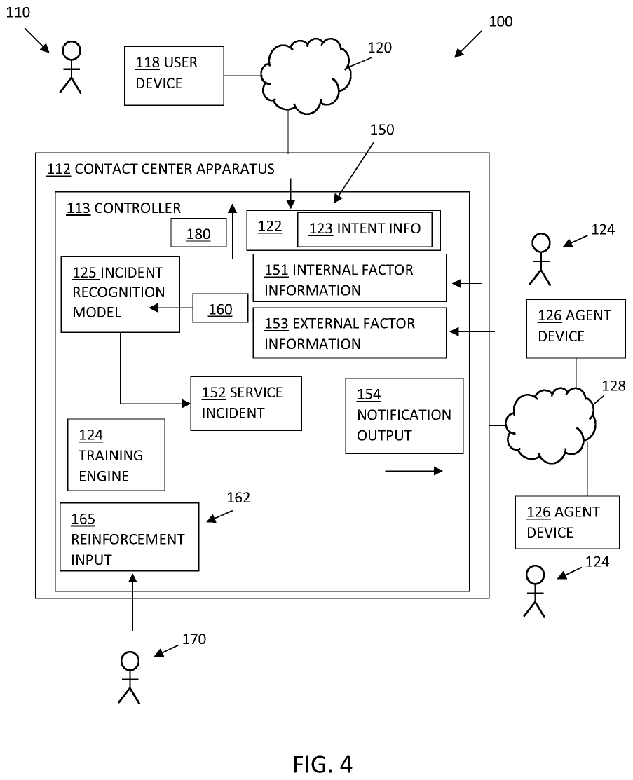

In element 202, the contact center apparatus 112 is configured to receive real-time data 150 from a data source, the real-time data 150 identifying a reported incident associated with a service. The contact center apparatus 112 can receive or compile the real-time data 150 from a variety of sources. For example, with reference to FIG. 4, a service user 110 can provide, as the real-time data 150, user communication 122 to the contact center apparatus 112 which can identify the service user's perceived issue with a given service. In the case where the contact center apparatus 112 operates on behalf of a hospital, the user communication 122 can report an emergency situation involving mass injuries or casualties. In the case where the contact center apparatus 112 operates on behalf of an electric company, the user communication 122 can indicate that the service user 110 is experiencing a power outage. In another example, the contact center apparatus 112 can receive an autonomous stream of updated, real time data 150, such as a local police radio feed or local weather feed.

Returning to FIG. 3, in element 204, the contact center apparatus 112 is configured to apply the real-time data 150 to the incident recognition model 125, the incident recognition model 125 configured to identify a state of the service provided by the service provider. For example, the contact center apparatus 112 can apply the user communication 122 to the incident recognition model 125 where the user communication 122 identifies a possible incident associated with the service (e.g., power outage, Internet service outage, etc.), as perceived by the service user 110.

In element 206, in response to applying the real-time data 150 to the incident recognition model 125, the contact center apparatus 112 is configured to identify one of an absence of a service incident and a presence of a service incident 152 associated with the service provider. As provided above, the contact center apparatus 112 develops the incident recognition model 125 based upon robust feature vectors 117 which can include a number of elements. Accordingly, application of the real-time data 150, such as the user communication 122, to the incident recognition model 125 can provide a relatively accurate identification of an incident associated with the service provider.

In element 208, in response to identifying the presence of the service incident 152, outputting an incident notification 154 to a contact center agent device 126. Based upon the identification of the service incident 152, in one arrangement, the contact center apparatus 112 is configured to generate an incident notification 154, such as a report, which identifies the presence of a service incident (e.g., power outage, Internet service outage, etc.) relative to the service provider. For example, with reference to FIG. 4, the contact center apparatus 112 can provide the incident notification 154 to one or more agent devices 126 via network 128. From there, the associated agents 124 can provide an expedited response to the incident notification 154 in a cost, and user-experience, efficient manner. For example, with the incident report of the user communication 122 being confirmed as an actual service incident by the contact center apparatus 112, an agent 124 can initiate a service response or truck roll. Further the agent 124 can instruct the contact center apparatus 112, via the agent device 126, to generate a response 180 to the service incident 152, such as by notifying additional calling customers that the provider is aware of the incident and to let the customer know when the service issue is addressed (e.g., power or Internet service restored).

As provided above, the real-time data 150 received by the contact center apparatus 112 can be in the form of user communication 122. However, assume the contact center apparatus 112 receives a user communication 122 indicating the service user's 110 cable service is inoperative. While the user communication 122, as received from a single service user 110, can identify a perceived service provider-wide cable service outage, such communication 122 may not be indicative of the actual presence or absence of a widespread service outage. For example, the contact center apparatus 112 is configured to detect additional information related to the user communication 122 and to provide that additional information to the incident recognition model 125 to identify the presence or absence of a provider incident. Use of the additional information can increase the accuracy of the detection of the presence or absence of a service incident.

In one arrangement, with reference to FIG. 4, the contact center apparatus 112 is configured to identify intent information 123 associated with the user communication 122 received from the service user 110 and to apply the user communication 122 and the intent information 123 to the incident recognition model 125 to identify the presence or absence of a provider incident. While the contact center apparatus 112 can identify the intent of the service user 110 in a variety of ways, in one arrangement, the contact center apparatus 112 can be configured to identify the intent of the service user 110 as described in U.S. patent application Ser. No. 17/126,703 which is entitled “Method and Apparatus for Intent Recognition and Intent Prediction Based Upon User Interaction and Behavior,” the contents and teachings of which are hereby incorporated by reference in their entirety.

In another arrangement, the contact center apparatus 112 is configured to receive internal factor information 151 as part of the real-time data 150 and can apply the user communication 122 and the internal factor information 151 to the incident recognition model 125 to identify the presence or absence of a provider incident. The internal factor information 151 can be associated with data generated by the service provider. For example, the contact center apparatus 112 can retrieve internal factor information 151, such as a number of calls or volume of interactions (e.g., dequeue rate), queued interactions (e.g., number of calls in the queue), and infrastructure hierarchy, as associated with the contact center system 10. When compiling these internal factor information elements as part of the real-time data 150, the contact center apparatus 112 can arrange the elements as one or more feature vectors 160 and can provide the feature vectors 160 and the user communication 122 as real-time data 150 to the incident recognition model 125. The incident recognition model 125 utilizes the feature vectors 160 in combination with the user communication 122 and can generate a service incident 152 which identifies that the user communication 122 more likely relates to a service incident (e.g., power or Internet service outage).

In another arrangement, the contact center apparatus 112 is configured to receive external factor information 153 as part of the real-time data 150 and can apply the user communication 122 and the external factor information 153 to the incident recognition model 125 to identify the presence or absence of a provider incident. The external factor information 153 can data generated external to, and independent of, the service provided by the service provider. For example, the contact center apparatus 112 can retrieve external factor information 153, such as seasonal information, maintenance information, public service data, infrastructure hierarchy information, and weather data. When compiling these external factor information elements as part of the real-time data 150, the contact center apparatus 112 can arrange the elements as a set of feature vectors 160 and can provide the feature vectors 160 and the user communication 122 as real-time data 150 to the incident recognition model 125. The incident recognition model 125 utilizes the feature vectors 160 in combination with the user communication 122 and can generate a service incident 152 which identifies that the user communication 122 more likely relates to a service incident (e.g., power or Internet service outage).

As provided above, in response to identifying the presence of a service incident, the contact center apparatus 112 is configured to output an incident notification 154 to a contact center agent device 126 in order to initiate a service response to the incident. However, the contact center apparatus 112 can be configured to provide the incident notification 154 to other recipients for feedback to improve operation of the system 100.

In one arrangement, the contact center apparatus 112 is configured to receive reinforcement input 165 from a human expert 170, based upon the incident notification 154, to reinforce the incident recognition model 125. For example, the contact center apparatus 112 can provide the incident notification 154 along with a feature vector 160 to an expert 170, such as a human expert, for review. The expert 170 can assess whether or not the identified incident is an actual incident or an error. For example, the expert 170 can track social media data from various social media platforms for mentions of the system's service to assess if the mentions are positive or negative (e.g., review FACEBOOK to determine whether or not users are complaining about outages in the service). In the case where the expert 170 detects that the generation of the incident identification 152 was made in error (i.e., no incidents reported on social media), the expert 170 can adjust the values of one or more of the feature vector elements (e.g., <infrastructure hierarchy>, <infrastructure state>, <maintenance information>, etc.) and can provide the resulting revised feature vector as reinforcement input 165 to the training engine 124. This, in turn, can cause the training engine 124 to adjust or update the incident recognition model 125 based upon the reinforcement input 165 in order to account for the changes to the feature vector elements. Accordingly, the input from the human expert 170 allows the incident recognition model 125 to improve its decision making process over time.

As provided above, the contact center apparatus 112 utilizes the incident recognition model 125 to identify the presence or absence of an incident associated with a service provider's service. In one arrangement, the contact center apparatus 112 is configured to assess the accuracy of the incident recognition model 125.

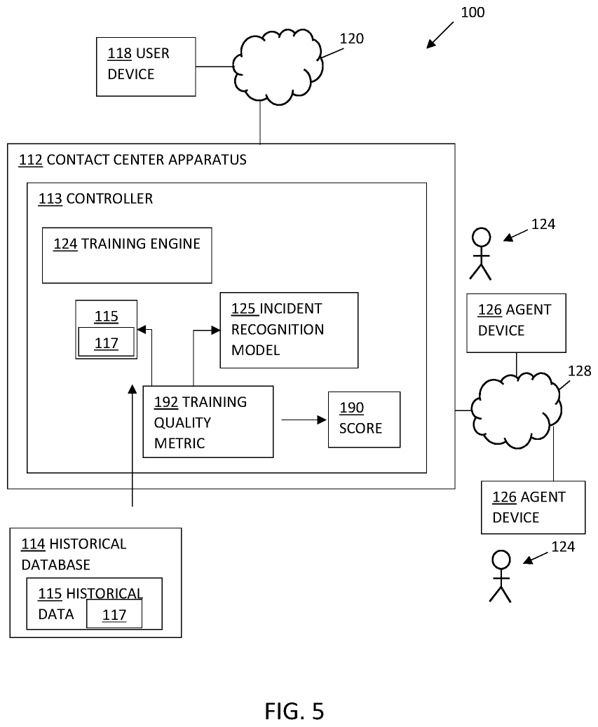

For example, With reference to FIG. 5, during the generation of the incident recognition model 125, the contact center apparatus 112 can be configured to generate a score 190 which quantifies the accuracy or quality for the incident recognition model 125. While the contact center apparatus 112 can generate the score 190 in a variety of ways, in one arrangement the contact center apparatus 112 is configured to apply a training quality metric 192, such as a mean absolute error (MAE) metric to the incident recognition model 125, to generate the score and to allow assessment of the accuracy of the incident recognition model 125.

For example, following the generation of the incident recognition model 125, the contact center apparatus 112 is configured to apply the training quality metric 192 to the contact historical data 115 and to the incident recognition model 125. In one arrangement, the training quality metric 192 is configured as a function which quantifies the fit between the incident recognition model 125 and the historical data 115 set to the model 125. As such, by applying the training quality metric 192 to the historical data 115 and to the incident recognition model 125, the contact center apparatus 112 can identify the fit and can generate, as an output an accuracy score 190 or model quality value associated with the incident recognition model 125. In the case where the contact center apparatus 112 generates a relatively low score 190, a contact center apparatus operator can update the incident recognition model 125 to increase the accuracy of its predictions. In the case where the contact center apparatus 112 generates a relatively high score 190, the contact center apparatus operator can decide to utilize the incident recognition model 125 without further modification.

As provided above, the contact center apparatus 112 is configured to receiving real-time data 150, such as user communication 122, to identify the presence of an incident relative to a service provider. In one arrangement, the contact center apparatus 112 can be configured to identify the presence of a service provider incident independent from the receipt of user communication 122 as the real time data 150. For example, the contact center apparatus 112 can be configured utilize external factor information 151 as the real time data 150 to identify the presence of a service provider incident.

In one arrangement, with reference to FIG. 4, the contact center apparatus 112 can receive external factor information 153 such as seasonal information, maintenance information, public data of services, infrastructure state, and weather data, and can apply the external factor information 153 to the incident recognition model 125, independent of receiving notification from a user 110 via the user communication 122. For example, the infrastructure state can identify that a majority of modems in a service provider's system are active while the seasonal information can identify the date as being the day after Thanksgiving. With application of these two elements of the external factor information 153 to the incident recognition model 125, the contact center apparatus 112 can predict an overload of the system, based upon historical data. In the case of such a prediction, the contact center apparatus 112 can provide a proactive notification 180 to the service users 110 to prepare for an incident (e.g. power outage).

While various embodiments of the innovation have been particularly shown and described, it will be understood by those skilled in the art that various changes in form and details may be made therein without departing from the spirit and scope of the innovation as defined by the appended claims.

What is claimed is:

1. In a contact center apparatus, a method for identifying an incident associated with a service provided by a service provider, comprising:
receiving real-time data from a data source, the real-time data identifying a reported incident associated with a service;
applying the real-time data to an incident recognition model, the incident recognition model configured to identify a state of the service provided by the service provider;
in response to applying the real-time data to an incident recognition model, identifying one of an absence of a service incident and a presence of a service incident associated with the service provider; and
in response to identifying the presence of the service incident, outputting an incident notification to a contact center agent device.

2. The method of claim 1, wherein:
receiving real-time data from the data source comprises receiving user communication from a service user, the user communication identifying the reported incident associated with the service;
applying the real-time data to the incident recognition model comprises applying the user communication to the incident recognition model; and
in response to applying the user communication to the incident recognition model, identifying one of the absence of a service incident and the presence of a service incident associated with the service provider.

3. The method of claim 1, wherein:
receiving real-time data from the data source comprises:
receiving user communication from a service user, the user communication identifying the reported incident associated with the service, and
identifying intent information associated with the user communication received from the service user;
applying the real-time data to the incident recognition model comprises applying the user communication and the intent information to the incident recognition model; and
in response to applying the user communication and the intent information to the incident recognition model, identifying one of the absence of a service incident and the presence of a service incident associated with the service provider.

4. The method of claim 1, wherein:
receiving real-time data from the data source comprises:
receiving user communication from a service user, the user communication identifying the reported incident associated with the service, and
receiving internal factor information, the internal factor information associated with data generated by the service provider;
applying the real-time data to the incident recognition model comprises applying the user communication and the internal factor information to the incident recognition model; and
in response to applying the user communication and the internal factor information to the incident recognition model, identifying one of the absence of a service incident and the presence of a service incident associated with the service provider.

5. The method of claim 1, wherein:
receiving real-time data from the data source comprises:
receiving user communication from a service user, the user communication identifying the reported incident associated with the service, and
receiving external factor information, the external factor information associated with data generated external to the service provider;
applying the real-time data to the incident recognition model comprises applying the user communication and the external factor information to the incident recognition model; and
in response to applying the user communication and the external factor information to the incident recognition model, identifying one of the absence of a service incident and the presence of a service incident associated with the service provider.

6. The method of claim 1, wherein:
receiving real-time data from the data source comprises receiving external factor information the external factor information associated with data generated external to the service provider;
applying the real-time data to the incident recognition model comprises applying the external factor information to the incident recognition model; and
in response to applying the external factor information to the incident recognition model, identifying one of the absence of a service incident and the presence of a service incident associated with the service provider.

7. The method of claim 1, further comprising:
applying a training quality metric to the incident recognition model; and
generating an accuracy score associated with the incident recognition model based upon application of the training quality metric.

8. The method of claim 1, wherein outputting the incident notification to the contact center agent device further comprises:
receiving reinforcement input from a human expert; and
adjusting the incident recognition model based upon the reinforcement input.

9. The method of claim 1, wherein outputting the incident notification to the contact center agent device further comprises generating a response to the service incident.

10. The method of claim 1, comprising:
receiving historical data from a historical data database; and
applying the historical data to an incident recognition framework to generate the incident recognition model.

11. The method of claim 10, wherein the historical data is defined as a feature vector comprising the elements: <seasonal information>, <number of calls>, <queued interactions>, <intent>, <infrastructure hierarchy>, and <infrastructure state>.

12. A contact center apparatus, comprising:
a controller having a processor and memory, the controller configured to:
receive real-time data from a data source, the real-time data identifying a reported incident associated with a service;
apply the real-time data to an incident recognition model, the incident recognition model configured to identify a state of a service provided by q service provider;
in response to applying the real-time data to an incident recognition model, identify one of an absence of a service incident and a presence of a service incident associated with the service provider; and
in response to identifying the presence of the service incident, output an incident notification to a contact center agent device.

13. The contact center apparatus of claim 12, wherein:
when receiving real-time data from the data source, the contact center apparatus is configured to receive user communication from a service user, the user communication identifying the reported incident associated with the service;
when applying the real-time data to the incident recognition model, the contact center apparatus is configured to apply the user communication to the incident recognition model; and
in response to applying the user communication to the incident recognition model, the contact center apparatus is configured to identify one of the absence of a service incident and the presence of a service incident associated with the service provider.

14. The contact center apparatus of claim 12, wherein:
when receiving real-time data from the data source, the contact center apparatus is configured to:
receive user communication from a service user, the user communication identifying the reported incident associated with the service, and
identify intent information associated with the user communication received from the service user;
when applying the real-time data to the incident recognition model, the contact center apparatus is configured to apply the user communication and the intent information to the incident recognition model; and
in response to applying the user communication and the intent information to the incident recognition model, the contact center apparatus is configured to identify one of the absence of a service incident and the presence of a service incident associated with the service provider.

15. The contact center apparatus of claim 12, wherein:
when receiving real-time data from the data source, the contact center apparatus is configured to:
receive user communication from a service user, the user communication identifying the reported incident associated with the service, and
receive internal factor information, the internal factor information associated with data generated by the service provider;
when applying the real-time data to the incident recognition model, the contact center apparatus is configured to apply the user communication and the internal factor information to the incident recognition model; and
in response to applying the user communication and the internal factor information to the incident recognition model, the contact center apparatus is configured to identify one of the absence of a service incident and the presence of a service incident associated with the service provider.

16. The contact center apparatus of claim 12, wherein:
when receiving real-time data from the data source, the contact center apparatus is configured to:
receive user communication from a service user, the user communication identifying the reported incident associated with the service, and
receive external factor information, the external factor information associated with data generated external to the service provider;
when applying the real-time data to the incident recognition model, the contact center apparatus is configured to apply the user communication and the external factor information to the incident recognition model; and
in response to applying the user communication and the external factor information to the incident recognition model, the contact center apparatus is configured to identify one of the absence of a service incident and the presence of a service incident associated with the service provider.

17. The contact center apparatus of claim 12, wherein:
when receiving real-time data from the data source, the contact center apparatus is configured to receive external factor information the external factor information associated with data generated external to the service provider;
when applying the real-time data to the incident recognition model, the contact center apparatus is configured to apply the external factor information to the incident recognition model; and
in response to applying the external factor information to the incident recognition model, the contact center apparatus is configured to identify one of the absence of a service incident and the presence of a service incident associated with the service provider.

18. The contact center apparatus of claim 12, wherein the contact center apparatus is further configured to:
apply a training quality metric to the incident recognition model; and
generate an accuracy score associated with the incident recognition model based upon application of the training quality metric.

19. The contact center apparatus of claim 12, wherein when outputting the incident notification to the contact center agent device, the contact center apparatus is further configured to:
receive reinforcement input from a human expert; and
adjust the incident recognition model based upon the reinforcement input.

20. The contact center apparatus of claim 12, wherein when outputting the incident notification to the contact center agent device, the contact center apparatus is configured to generate a response to the service incident.

21. The contact center apparatus of claim 12, the contact center apparatus is configured to:
receive historical data from a historical data database; and
apply the historical data to an incident recognition framework to generate the incident recognition model.

22. The contact center apparatus of claim 21, wherein the historical data is defined as a feature vector comprising the elements: <seasonal information>, <number of calls>, <queued interactions>, <intent>, <infrastructure hierarchy>, and <infrastructure state>.
